(19) United States
(12) Patent Application Publication
(10) Pub. No.: US 2025/0045887 A1
(43) Pub. Date: Feb. 6, 2025

(54) SYSTEMS AND METHODS TO GENERATE HIGH DYNAMIC RANGE SCENES

(71) Applicant: DEPIX TECHNOLOGIES INC., Montréal (CA)

(72) Inventors: Mathieu GARON, Sutton (CA); Etienne DUBEAU, Québec (CA); Henrique WEBER, Laval (CA); Yulian TSEPENDA, Lviv (UA)

(73) Assignee: DEPIX TECHNOLOGIES INC., Montréal (CA)

(21) Appl. No.: 18/791,924

(22) Filed: Aug. 1, 2024

Related U.S. Application Data
(60) Provisional application No. 63/517,435, filed on Aug. 3, 2023.

(51) Int. Cl. G06T 5/90; G06T 5/20; G06T 5/77; G06V 20/70

(52) U.S. Cl. CPC G06T 5/90; G06T 5/20; G06T 5/77; G06V 20/70; G06T 2207/20208

(57) ABSTRACT

The present disclosure provides computer-implemented methods and systems to generate high dynamic range (HDR) panoramas to render virtual objects. A low dynamic range (LDR) panorama from a prompt describing a desired aspect of a panorama. The LDR panorama is then converted to an HDR panorama. The process can include generating a backplate image using a first machine learning model, projecting the image onto a sphere and inpainting it using a second machine learning model to generate an LDR panorama, and converting the LDR panorama to an HDR panorama using a third machine learning model. Each of the 10 first, second and third machine learning models can be diffusion models. Alternatively, the third machine learning model can be a convolutional neural network model. A physics-based rendering engine can then be used to render a virtual object in the HDR panorama.

### CROSS-REFERENCE TO RELATED APPLICATION

This application claims the benefit of and priority to U.S. Provisional Patent Application No. 63/517,435, filed Aug. 3, 2023, and entitled “SYSTEMS AND METHODS TO GENERATE HIGH DYNAMIC RANGE SCENES FROM TEXT”, the disclosure of which is hereby incorporated by reference in its entirety.

### TECHNICAL FIELD

The technical field relates to digital image processing, and more specifically to systems and methods for generating a high dynamic range (HDR) panorama from a user-provided prompt that is suitable to render a scene including a virtual object with realistic shadows and high-resolution reflections.

### BACKGROUND

In product manufacturing, it is common to first create a 3D model of a product and use the model to create compelling images in order to better visualize how the product fits in specific contexts for marketing purpose. Current traditional pipelines require finding a photograph, positioning the 3D model correctly in the viewpoint of the photograph, and manually defining lighting parameters that create suitable reflections, shading and colour in the final render. This process is either manual or requires the capture of an HDR light probe in the scene from the photograph. In either case this process is costly.

### SUMMARY

We propose a novel framework that allows to simplify this process by: 1) letting the user define the image in which to render their content with simple inputs; and 2) generating HDR panoramas associated to this image to seamlessly render the 3D model with realistic shadow and high-resolution reflections.

In accordance with an aspect, a computer-implemented method to generate a high dynamic range (HDR) panorama is provided. The method includes receiving a prompt describing a desired aspect of a panorama, generating, by a panorama generator, a low dynamic range (LDR) panorama from the prompt, and generating, by an LDR-to-HDR converter, the HDR panorama from the LDR panorama.

In accordance with another aspect, a computing system to generate an HDR panorama is provided. The computing system includes a panorama generator configured to generate an LDR panorama from a user-provided prompt, and an LDR-to-HDR converter configured to convert the LDR panorama into the HDR panorama.

In accordance with a further aspect, a non-transitory computer-readable medium having instructions stored thereon is provided. The instructions, when executed by one or more processors, cause the one or more processors to generate, by a panorama generator, an LDR panorama from a user-provided prompt describing a desired aspect of a panorama, and generate, by an LDR-to-HDR converter, an HDR panorama from the LDR panorama.

In some embodiments, generating the low dynamic range panorama includes generating a backplate image from the prompt using a first machine learning model trained to generate an image based at least on an input prompt, and generating the LDR panorama from the backplate image by at least one of: projecting the backplate image onto a sphere, and inpainting the backplate image.

Some embodiments include rendering a virtual object in the HDR panorama using a physics-based render engine.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment.

FIG. 1A is a schematic of a system for generating an HDR panorama according to user directions and realistically rendering a 3D model of a virtual object using the panorama as background, in accordance with an embodiment applied on a first example.

FIG. 1B is a schematic of the system of FIG. 1A applied to a second example.

FIG. 2A1 is a schematic of a subsystem for converting an LDR panorama to an HDR panorama, in accordance with an embodiment applied on the first example.

FIG. 2A2 is a schematic of the subsystem of FIG. 2A1 applied to the second example.

FIGS. 2B1 and 2B2 are examples showing an anlarged portion of low-detail, variably exposed panoramas, produced by the subsystem of FIG. 2A1 respectively to the first and second examples.

FIGS. 2C1 and 2C2 are examples showing an anlarged portion of high-detail, variably exposed panoramas, produced by the subsystem of FIG. 2A1 respectively to the first and second examples.

FIG. 3 is a flowchart of a method for generating an HDR panorama according to user directions and realistically rendering a 3D model of a virtual object using the panorama as background, in accordance with an embodiment.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practised without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

One or more systems described herein may be implemented in computer program(s) executed on processing device(s), each comprising at least one processor, a data storage system (including volatile and/or non-volatile memory and/or storage elements), and optionally at least one input and/or output device. “Processing devices” encompass computers, servers and/or specialized electronic devices which receive, process and/or transmit data. As an example, “processing devices” can include processing means, such as microcontrollers, microprocessors, and/or CPUs, or be implemented on FPGAs. For example, and without limitation, a processing device may be a programmable logic unit, a mainframe computer, a server, a personal computer, a cloud-based program or system, a laptop, a personal data assistant, a cellular telephone, a smartphone, a wearable device, a tablet, a video game console or a portable video game device.

Each program is preferably implemented in a high-level programming and/or scripting language, for instance an imperative e.g., procedural or object-oriented, or a declarative e.g., functional or logic, language, to communicate with a computer system. However, a program can be implemented in assembly or machine language if desired. In any case, the language may be a compiled or an interpreted language. Each such computer program is preferably stored on a storage media or a device readable by a general or special purpose programmable computer for configuring and operating the computer when the storage media or device is read by the computer to perform the procedures described herein. In some embodiments, the system may be embedded within an operating system running on the programmable computer.

Furthermore, the system, processes and methods of the described embodiments are capable of being distributed in a computer program product comprising a computer readable medium that bears computer-usable instructions for one or more processors. The computer-usable instructions may also be in various forms including compiled and non-compiled code.

The processor(s) are used in combination with storage medium, also referred to as “memory” or “storage means”. Storage medium can store instructions, algorithms, rules and/or trading data to be processed. Storage medium encompasses volatile or non-volatile/persistent memory, such as registers, cache, RAM, flash memory, ROM, diskettes, compact disks, tapes, chips, as examples only. The type of memory is, of course, chosen according to the desired use, whether it should retain instructions, or temporarily store, retain or update data. Steps of the proposed method are implemented as software instructions and algorithms, stored in computer memory and executed by processors.

It is understood that the neural networks described herein can be implemented using computer hardware elements, computer software elements or a combination thereof. Accordingly, the neural networks and additional submodules described herein can be referred to as being computer-implemented. Various computationally intensive tasks of the neural network can be carried out on one or more processors (central processing units and/or graphical processing units) of one or more programmable computers. For example, and without limitation, the programmable computer may be a programmable logic unit, a mainframe computer, server, personal computer, cloud-based program or system, laptop, personal data assistant, cellular telephone, smartphone, wearable device, tablet device, virtual reality device, smart display devices such as a smart TV, set-top box, video game console, or portable video game device, among others.

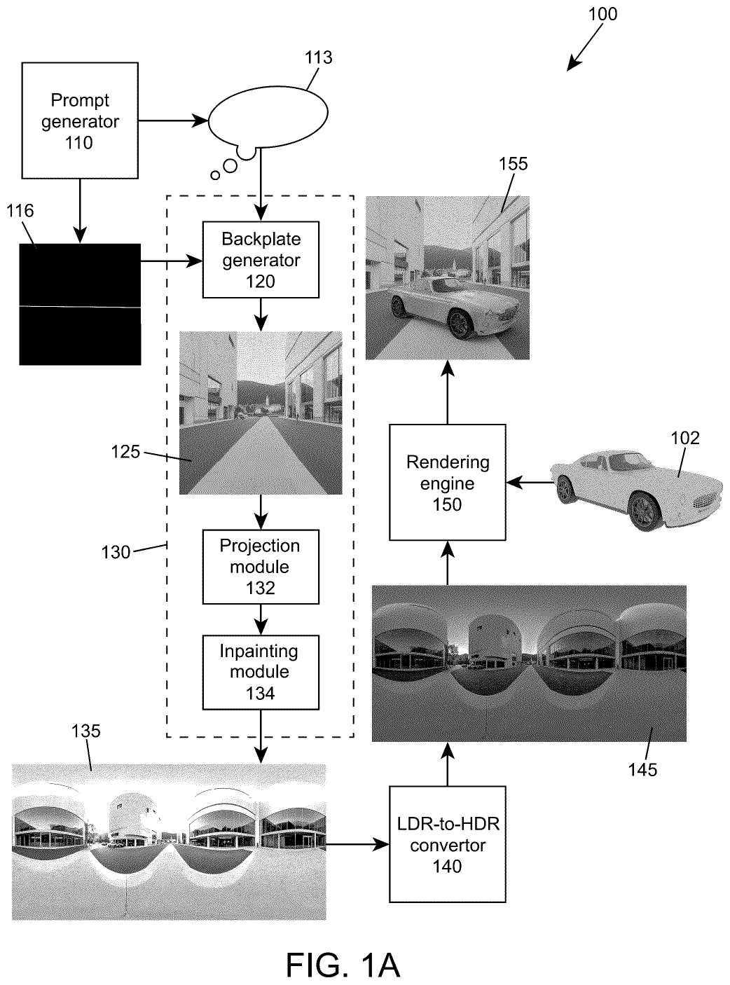

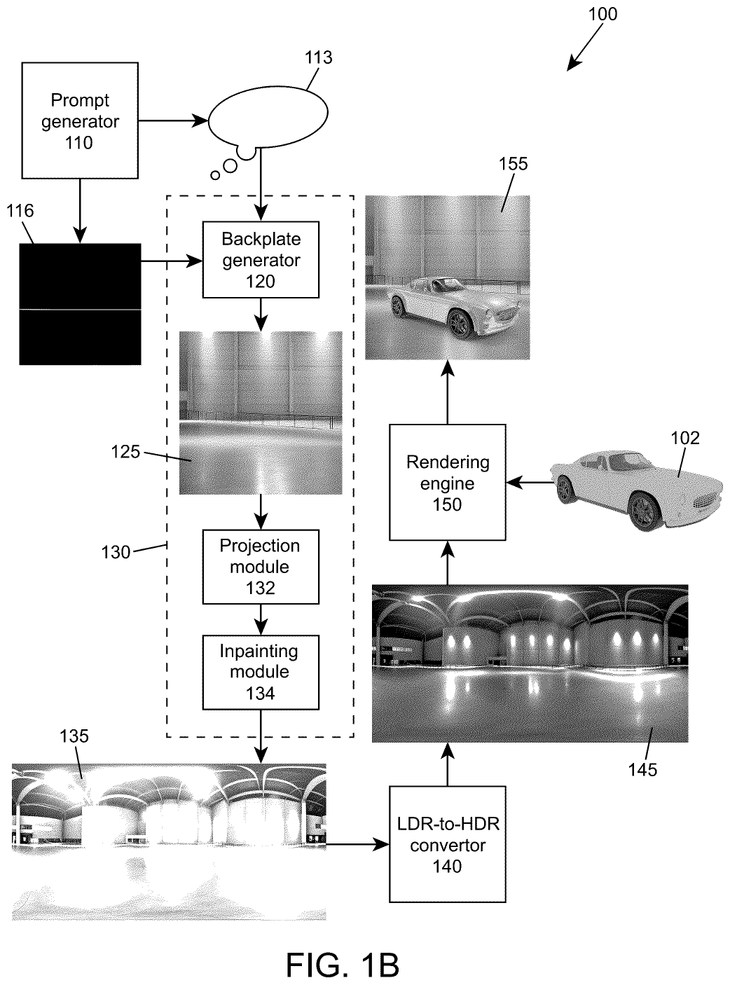

With reference to FIGS. 1A and 1B, an exemplary system 100 for generating a high dynamic range (HDR) panorama according to user directions and realistically rendering a 3D model of a virtual object using the panorama as background is shown according to an embodiment and illustrated on two examples using the same virtual object but different prompts. The user can provide a 3D model of a virtual object 102, e.g., a sports car, and a prompt describing a desired context in which to render the virtual object, e.g., “Austria space Europe” (FIG. 1A) and “light stadium flooring concrete structure warehouse interior” (FIG. 1B). Broadly described, the system 100 can include a prompt generator 110 to generate an enhanced version of a user-received caption or prompt 113, and in some embodiments generate a sketch 116, for use by a panorama generator 130 to create a low dynamic range (LDR) panorama 135. The system 100 further includes an LDR-to-HDR convertor 140, which converts the LDR panorama 135 into an HDR panorama 145. The system 100 can include a rendering engine 150, also called render engine, to composite a virtual object 102 in the HDR panorama 150, generating a rendered scene 155.

Rendering a 3D model of a virtual object in a realist context can require having a perfect knowledge of the scene in which it will be integrated. The geometry must be known in order to position the object correctly, and the lighting condition must be estimated in order to properly compute lighting interactions between the object and the scene. Traditional methods propose extracting this information from a photograph, but provide limited control over the conditions of the photograph. The systems and methods described herein propose providing control to the user using text prompts in order to create the full environment in which the 3D model will be rendered.

The system 100 is configured to receive a text prompt, also called “caption” or “context control”, describing a desired aspect of the panorama from the user. In some embodiments, the text prompt can be used as input of the panorama generator 130. In some embodiments, the system 100 includes a prompt generator 110 configured to enhance the prompt provided by the user before it is used as input of the panorama generator 130, and/or to produce a sketch 116 used to condition the panorama generator 130.

In some embodiments, for the prompt generator 110 to build the enhanced prompt 113, the user can be asked to provide desired camera and/or lighting parameters.

Camera parameters can for instance include a camera height and angle, together defining a camera elevation. Lighting parameters can for instance include ambient light intensity and main light source position and/or direction. In some embodiments, the user can additionally or alternatively provide an image, e.g., a photograph, from which parameters such as a camera height and angle and lighting parameters can be extracted. The lighting parameters can advantageously be described with specific tags that are standardized with respect to a given embodiment, for instance using expressions on a continuum from “dark” to “saturated” and directions such as “light from left”, “light from right”, “light from top” etc. As an example, a prompt that reads “a beach with palm trees with a sunset detected as low ambient but light coming from the sun behind” can be enhanced by standardizing it as “a beach with palm trees photographed with low ambient light and a strong light in front”. During inference this context can allow more control on the various parameters generated by the user. In some embodiments, the user can choose among predefined tags for the desired lighting and camera parameters. In some embodiments, a camera elevation can be used as a line drawing computed from the height and the angle of the camera. In some embodiments, an elevation sketch 116 is generated using the camera height and angle, and can be provided to the generative machine learning model as an additional input through a suitable means. In some embodiments, a scene with an infinite horizon and the camera located in the scene based on the camera parameters is created and used to generate a depth map, i.e., a map indicating the depth of each pixel as perceived from the camera viewpoint, providing a more precise description of the ground plane. The depth map can for instance illustrate a gradient of smaller distance values near the camera and larger distance values for pixels approaching the horizon line. The depth map can be provided to the generative machine learning model, in addition or as an alternative to the sketch 116, through a suitable means. As an example, if the machine learning model is a diffusion model, it is possible to use a ControlNet block trained specifically for the task of conditioning the diffusion model based on the sketch 116 and/or on the depth map.

The system 100 includes a panorama generator 130, which is responsible for generating an LDR panorama 135 based on the prompt 113 and in some embodiments also based on the sketch 116.

In some embodiments, the panorama generator 130 includes a backplate generator 120 which is responsible for generating a backplate image 125 which the panorama generator 130 is further configured to convert into an LDR panorama 135. The backplate generator 120 can include any suitable machine learning model, such as variational autoencoders, autoregressive models, generative adversarial networks, energy-based models and/or diffusion models. In some embodiments, the backplate generator can be a multimodal neural network, trained for instance to receive a text prompt 113 as its input and generate an output scene such as a backplate image 125 as its output. The model of the backplate generator 120 can be trained on a dataset of images specifically created to be used as product backplates. The images can represent various high quality scenes (advantageously with high variability) taken, for instance, by digital single-lens reflex (DSLR) cameras, and the training images can therefore be referred to as training scenes, or simply as scenes. In some embodiments, the composition is annotated at least with the height, angle and/or elevation of the camera during the capture. In some embodiments, empty space for the placement of a virtual object is part of some or every composition. In some embodiments, a caption predictor, for instance implementing a deep neural network, is used to caption all the images, i.e., to provide a training prompt associated with each image, for instance CLIP or BLIP. In some embodiments, a light estimation method can be used to extract information about the type of light intensity in the scene, i.e., to determine lighting parameters, for inclusion in the training prompt. From the predicted caption, and in some embodiments the height, angle, elevation and/or the light estimation, a new text prompt can be built, e.g., by the prompt generator 110. The new text prompt can be used as a training prompt to label the images during the training process, and can be used in the prompt generation module to condition the model with the proper commands.

During inference, a higher resolution can be preferable, therefore the backplate image can be generated at a resolution of 1024×1024 pixels, for example. In some embodiments, the backplate image and can be up-sampled using any suitable method. In some embodiments, the up-sampling method is a diffusion model. In some embodiments, the up-sampling model, e.g., the up-sampling diffusion model, is trained on the same dataset.

In some embodiments, the panorama generator 130 includes a projection module 132 and/or configured to generate a panorama, i.e., to generate what is “behind the camera”, from the prompt 113 and optionally the sketch 116, in some embodiments relying on the backplate image 125 generated by the backplate generator 120.

In some embodiments, the generated panorama can be the result of a projection in latitude and longitude format, also named “latlong format” by the projection module 132.

In some embodiments, the panorama generator 130 includes an inpainting module 134 including a machine learning model, e.g., a generative machine learning model such as a diffusion model, trained to perform panorama inpainting in order to complete the panorama. The machine learning model can for instance include a diffusion model trained on a suitably large dataset of LDR or HDR panoramas, e.g., a dataset containing more than 10,000 panoramas. In some embodiments, the panoramas can be captured with a high quality DSLR camera, for example mounted on a robotic head rotating on each scene to capture various exposures of the scene, and stitched, e.g., on a sphere. The exposures can be merged together with any suitable method. In some embodiments, a response of a photographic film to variations in exposure is recovered, for instance as a Hurter-Driffield curve and is used to construct a radiance map making it possible to convert pixel values of the exposure images to relative radiance values, thereby yielding an HDR image. To train the diffusion model, it can be preferable to have images that are in the same domain as more standard images. The panoramas can thus be projected in latlong format and, in some embodiments, tone-mapped, so as to look like standard low dynamic range (LDR) images.

To create proper captions for panoramas, several projections of the latlong panorama can be performed into different viewpoints by a projection module 132 of the panorama generator 130. Each viewpoint can then be captioned using a caption generator, e.g., CLIP or BLIP, to describe the content. The captions can then be concatenated with keywords based on the position of each projection to generate a large caption describing the panorama. As an example, the projection of six views similar to a cube map can be performed, with each projection labelled as “left”, “front”, “right”, “back”, “top” or “bottom”. Specifically, the left side can be captioned as “<caption>from left image”, where “<caption>” represents the output of the caption generator, the right side can be captioned as “<caption>from right image”, etc. The results can differ from prompts typically used to train standard diffusion models. Therefore, in some embodiments, the prompt is summarized using a generative language model, for instance a large language model (LLM). Summarizing the prompt can include providing a requirement that the prompt be formatted for the specific task of training the machine learning model. The generative language model can be used to summarize the prompt is a zero-shot, one-shot or few-shot manner. In some embodiments, the generative language model can be fine-tuned for the task of summarizing prompts. Using one of the prompting methods described above can allow more control on the position and content generated during the inference.

In some embodiments, the generative machine learning model of the inpainting module 134 can be trained to use the backplate image 125 projected on a suitable shape such as a sphere, a plane or a cylinder, as a latlong format image by the projection module 132 and to inpaint the rest of the image using the backplate image 125 as conditioning.

In some embodiments, a method for projecting on the shape can use metadata from the prompt, e.g., the elevation, and a selected field of view to populate intrinsic parameters of a camera. Using the intrinsic parameters, the image can be projected, e.g., on a sphere using the optical centre as the centre of projection, e.g., of the sphere. This method is simple and provides good global lighting that will generate good-looking reflections. However this method can be limited as it may not be aware of the geometry around the object, for instance of the presence of a wall nearby. To improve the reflections on the object, the depth can be estimated from the backplate image 125 using any suitable depth estimation method. The insertion point of the virtual object 102 can be used as the centre of projection, e.g., of the sphere. From that point, the depth can be used to re-project the estimated geometry from the backplate, e.g., onto the sphere at the given position. It is expected that the projection will be incomplete, and the machine learning model of the panorama generator 130 can then be used to inpaint missing areas where no information is available.

In some embodiments, the generated panorama is an LDR panorama 135 that represents accurate reflections on the model. To further improve the realism of the virtual object 102 inserted in the panorama, an estimated HDR panorama 145 can be generated from the LDR panorama 135 by the LDR-to-HDR convertor 140. This makes it possible to properly render high quality reflection and lighting on the virtual object 102. The generated HDR panorama 145 can have high dynamic range pixels, and therefore the absence of light in a pixel can be represented by a zero value and high intensity lights are not saturated, resulting for instance in a high value and colour for the sun.

In some embodiments, the LDR-to-HDR convertor includes a suitable machine learning model, e.g., a convolutional neural network model such as a U-Net model, trained, e.g., as a variational encoder, to accept an LDR panorama 135 as input and to generate a corresponding HDR panorama 145 as output. In some embodiments, the model of the LDR-to-HDR convertor 140 is trained using the same dataset as used to train the model of the panorama generator 130.

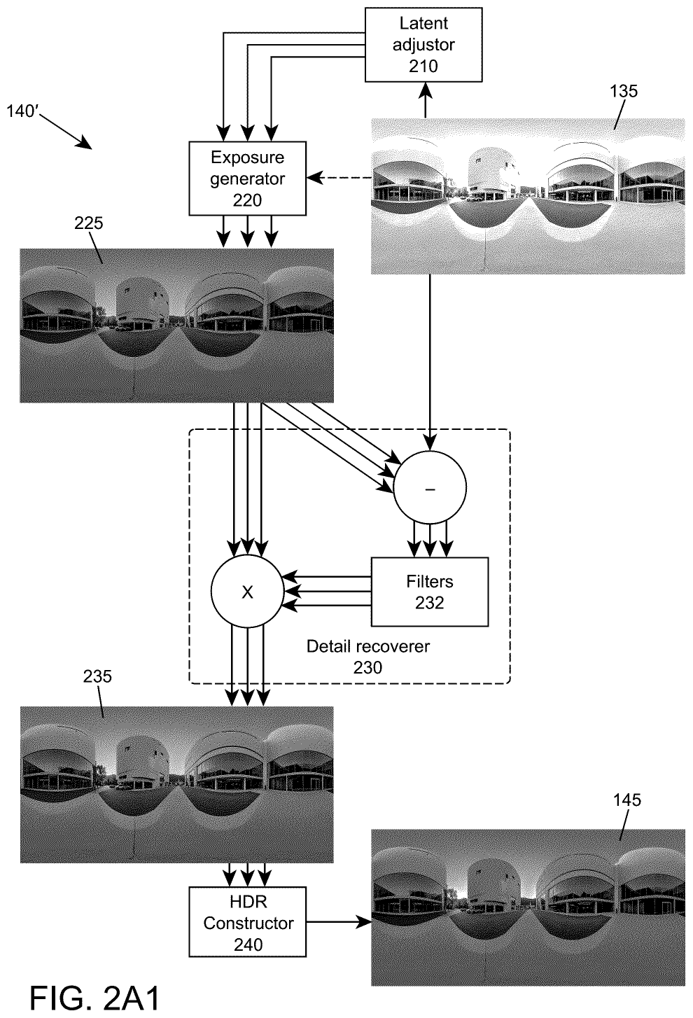

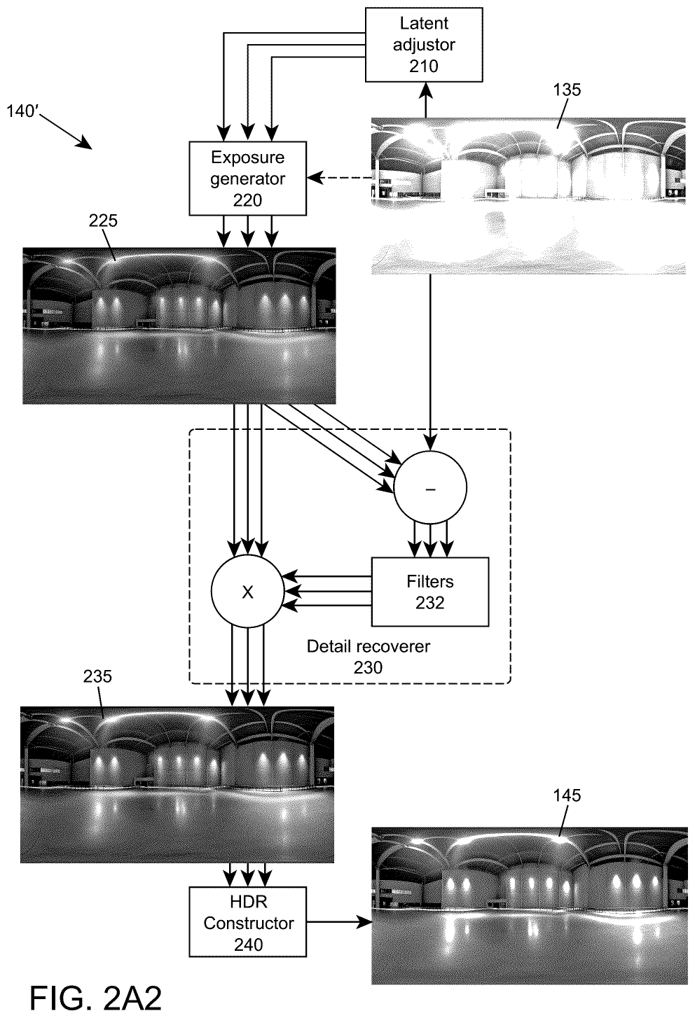

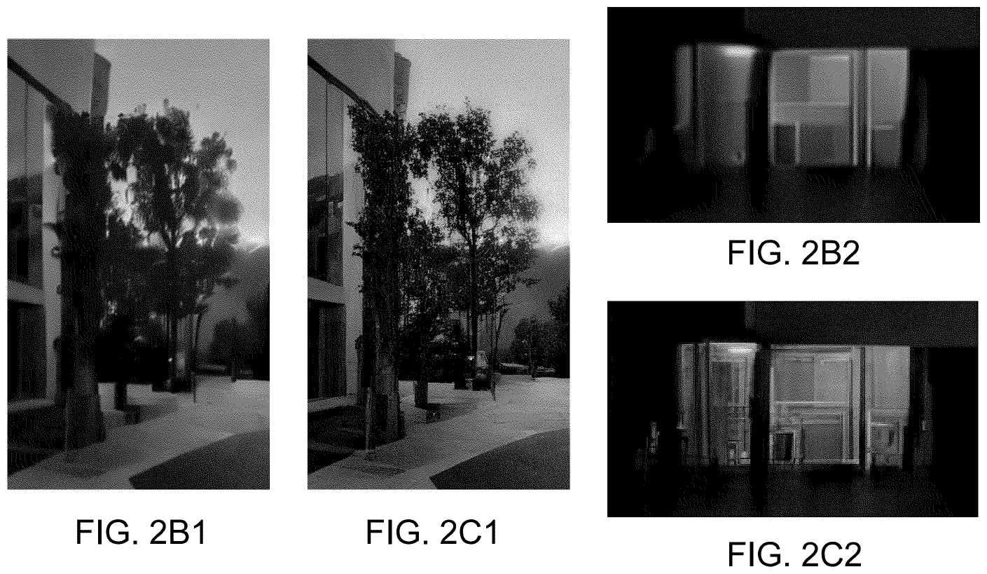

In some embodiments, the LDR-to-HDR convertor includes a machine learning model trained to generate LDR panoramas with a variety of exposures. With reference to FIGS. 2A1 and 2A2, an exemplary embodiment of an LDR-to-HDR convertor 140′ relying on an exposure generator 220 including a diffusion model trained to generate variably exposed LDR panoramas 225 is shown and illustrated on the two examples used in FIGS. 1A and 1B.

Triple arrow lines in FIGS. 2A1 and 2A2 indicate steps that can be executed once for each exposure, i.e., once for each of the generated variably exposed panoramas. In some embodiments, the number of exposures generated by the

LDR-to-HDR convertor 140′ is configurable. Generating at least two exposures allows converting the LDR panorama 135 to an HDR panorama 145. The specific number of exposures generated can be based on a tradeoff between quality and use of computational resources, with a higher number of exposures leading to a higher quality HDR panorama 145 and a lower number of exposures leading to a lower usage of computational resources and a faster inference.

The LDR-to-HDR convertor 140′ includes a latent adjustor 210 configured to adjust the latent encoding tensor (e.g., the latent encoding vector) based on a desired exposure level, i.e., to adjust a global luminance value of the latent tensor. In some embodiments, the latent adjustor 210 is configured to recentre the latent tensor, i.e., to adjust the mean value of each channel to achieve a desired colour balance, creating a recentred latent tensor. In some embodiments, the latent adjustor 210 is configured to rely on a suitable recentring implementation such as the ComfyUl Diffusion Color Grading extension. In some embodiments, in addition or as an alternative to enhancing the prompt 113 with lighting parameters, desired lighting parameters can additionally or alternatively be used to condition the generation of the variably exposed panoramas 225. As an example, an image can be created by projecting the lighting parameters, or a subset of the lighting parameters such as a position parameter, a direction parameter and/or a size parameter, to a panorama, for instance using the same type of projection (e.g., latlong projection onto a sphere) as used by the projection module 132. The image thus created can be described as a “lightmap”, and can be used to condition the diffusion model of the exposure generator 220 using a suitable method, for instance by configuring the latent adjustor 210 to apply pixel-wise modifications further guided by the lightmap to the latent tensor rather than global modifications, thereby providing for control of the light sources in the generation of variably exposed panoramas 225.

The LDR-to-HDR convertor 140′ includes an exposure generator 220 including the diffusion model. The LDR-to-HDR convertor 140′ can be configured to generate multiple variably exposed LDR panoramas 225, including for instance underexposed panoramas, based on the LDR panorama 135 generated by the panorama generator 130. In some embodiments, the LDR panorama 135 is provided as an image prompt to guide the diffusion model in generating the variably exposed panoramas 225 using a suitable method, such as a ControlNet, T2I-Adapters or the IP-Adapter.

In some embodiments, the LDR-to-HDR convertor 140′ includes a detail recoverer 230. It can be appreciated that regenerating variably exposed panoramas 225 based on the LDR panorama 135 can lead to a loss of detail in the images, resulting in what could be called “low-detail variably exposed panoramas”. FIGS. 2B1 and 2B2 show an enlarged portion of the low-detail variably exposed panoramas of FIGS. 2A1 and 2A2, respectively, illustrating loss of detail. The detail recoverer 230 is configured to aggregate each variably exposed panorama 225 with the LDR panorama 135, to retain the specific exposure parameters of panorama 225 while transferring some details of panorama 135. In some embodiments, filters, including for instance high-frequency filters such as a high-pass filter, can be applied to a panorama or an aggregation of panorama. As an example, one or more filter can be applied to an image resulting from the aggregation of the variably exposed panorama 225 and the LDR panorama 135, e.g., a subtraction of the variable exposed panorama 225 from the LDR panorama 135. The resulting filtered image can then be aggregated with the variably exposed panorama 225, e.g., by pixel-wise multiplication. It can be appreciated that various filters can be applied to various aggregations of original or intermediary images and that various processing techniques such as dynamic range clamping can be applied images in order to maximize the recovered level of detail and realism of the resulting image. The resulting image can be described as a high-detail variably exposed panorama 235. FIGS. 2C1 and 2C2 show an enlarged portion of the high-detail variably exposed panoramas of FIGS. 2A1 and 2A2, respectively, illustrating recovery of detail that was lost in FIGS. 2B1 and 2B2.

The LDR-to-HDR convertor 140′ includes an HDR constructor 240 configured to merge the multiple variably exposed panoramas 225 and/or high-detail variably exposed panoramas 235 in order to generate an HDR panorama 145 corresponding to the LDR panorama 135 generated by the panorama generator 130. The HDR constructor 240 can for instance be implemented as described above, i.e., it can be configured to construct an HDR radiance map based on the multiple variably exposed panoramas and use the radiance map to convert the LDR panorama 135 into the HDR panorama 145.

Referring back to FIG. 1A, the system 100 can include a rendering engine 150, for instance a physics-based rendering engine. The rendering engine 150 is configured to take as input the HDR panorama 145 and a 3D model of the virtual object 102, and to render a scene 155, also called render, including the virtual object 102 using the generated panorama as backplate, with the expected realistic shadows and high-resolution reflections made possible by the use of an HDR panorama 145.

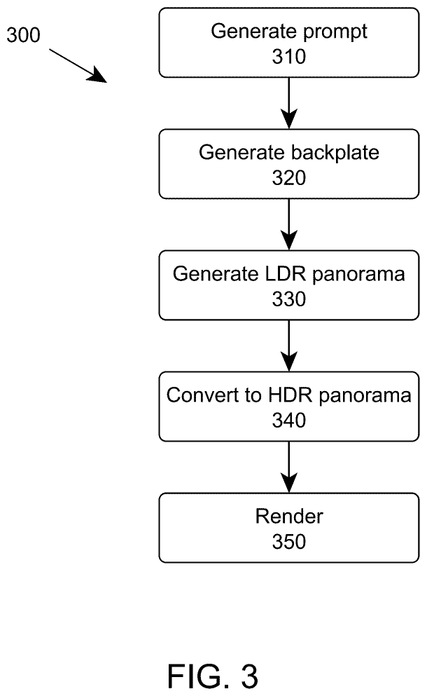

With reference to FIG. 3, an exemplary method 300 for generating an HDR panorama according to user directions and realistically rendering a 3D model of a virtual object using the panorama as background is shown according to an embodiment. Broadly described, method 300 includes a step of generating an LDR panorama 330 and a step of converting the generated panorama to an HDR panorama 340. In some embodiments, method 300 can include steps of generating a prompt 310 and/or a backplate 320, and/or of rendering the scene 350.

Method 300 includes receiving a text prompt describing the desired aspect of the panorama, for instance from a user. The text prompt can also be called a caption or a “context control” for the machine learning model(s) used to generate the panorama. In some embodiments, an enhanced prompt is generated in an initial step 310. Generating the prompt can include modifying a prompt provided by the user to account for desired lighting parameters in the panorama to be generated, including for instance an ambient intensity and a direction of the main light source. In some embodiments, a standardized vocabulary and/or syntax is used to provide indications of desired lighting parameters in the prompt. In some embodiments, generating the prompt can include rewording, summarizing and/or standardizing the original user-provided prompt or the generated enhanced prompt, for instance, to improve the performance of the machine learning model(s). As an example, capitalization can be standardized, e.g., the prompt can be converted to lower-case. In some embodiments, generating the prompt can include generating a sketch providing a visual indication of desired camera parameters, e.g., of an imaginary camera that could have captured the generated image, such as a height of the camera and/or an angle of the camera. The elevation sketch can for instance correspond to an image with a solid background of a first colour, displaying a single line of a second, contrasting colour.

Method 300 includes generating a panorama. In some embodiments, an LDR panorama is generated directly from the prompt and, optionally, the sketch. In some embodiments, a prior step 320 of generating a backplate is performed. Generating a backplate includes using a trained machine learning model to generate a backplate image based on the prompt and, optionally, the sketch. The model can for instance be a diffusion model, and the training method can be the one described above with respect to the backplate generator. Generating the backplate image can therefore include providing the prompt as input to a trained diffusion model, and using the output of the model as the backplate image. In some embodiments, the optional sketch can be provided as an additional input to the diffusion model using any suitable method. As an example, after the diffusion model is trained to generate backplate images based on prompt, a ControlNet can be trained to condition the diffusion model based on sketches.

Method 300 includes a step 330 of generating the LDR panorama. As described above, in some embodiments, the LDR panorama is generated directly from the prompt and, optionally, the sketch. In embodiments using step 320 of generating a backplate, step 330 can include performing transformations on the backplate image so that it can be used as an LDR panorama. In some embodiments, transforming the backplate in a panorama includes projecting the backplate image on a suitable shape such as a sphere using a suitable projection method such as latlong projection. In some embodiments, the process of projecting the backplate image is enhanced by first computing a depth map corresponding to the backplate image and projecting the backplate based on the depth. In some embodiments, transforming the backplate in a panorama includes inpaiting the backplate image or the projected backplate image. Inpainting the backplate image can include using a suitable inpaiting machine learning model. The training method can for instance be as described above with respect to the panorama generator.

Method 300 includes a step 340 of converting the LDR panorama generated in step 330 to an HDR panorama suitable to render a scene with realistic shadows and reflections. Converting the LDR panorama to an HDR panorama can include using a suitable trained machine learning model. It can be appreciated that different processes using different types of models are possible. In some embodiments, a convolutional neural network model is trained as described above with respect to the LDR-to-HDR convertor using a dataset of HDR images and corresponding synthetic LDR images, and can be used to take an LDR panorama as input and generate a corresponding HDR panorama as output. In some embodiments, a diffusion model can be used to generate multiple variably exposed versions of the LDR panorama, which can then be merged into an HDR panorama. The variable expositions can be generated by adjusting, e.g., recentring, the latent tensor denoised by the diffusion model in accordance with a variety of parameters. This process can further be improved by using the LDR panorama as an image prompt, and/or by aggregating the LDR panorama with the generated variably exposed panoramas and applying image processing techniques such as image filtering to retain a higher level of detail.

Method 300 can include a final step 350 of rendering a scene including a virtual object provided by the user inserted in the generated panorama. Using an HDR panorama makes it possible to render realistic shadows and high-resolution reflections.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. A computer-implemented method to generate a high dynamic range (HDR) panorama, the method comprising:
receiving a prompt describing a desired aspect of a panorama;
generating, by a panorama generator, a low dynamic range (LDR) panorama from the prompt; and
generating, by an LDR-to-HDR converter, the HDR panorama from the LDR panorama.

2. The method of claim 1, wherein generating the LDR panorama comprises:
generating a backplate image from the prompt using a first machine learning model trained to generate an image based at least on an input prompt; and
generating the LDR panorama from the backplate image by at least one of:
projecting the backplate image onto a sphere, and inpainting the backplate image.

3. The method of claim 2, wherein the first machine learning model is configured to be conditioned by an elevation sketch generated from a camera height input and a camera angle input.

4. The method of claim 2, wherein training the first machine learning model comprises:
providing a dataset comprising scenes annotated at least with a camera height and a camera angle;
determining a caption for each scene;
determining lighting parameters for each scene;
generating a training prompt for each scene from at least one of: the camera height, the camera angle, the caption, and the lighting parameters;
labelling each scene with the corresponding training prompt; and
training the first machine learning model to generate an output scene based at least in part on the training prompt.

5. The method of claim 2, wherein generating the LDR panorama from the backplate image comprises using a second machine learning model trained to generate the LDR panorama based at least on the backplate image, wherein the LDR panorama corresponds to an inpainting of the backplate image.

6. The method of claim 1, wherein generating the HDR panorama from the LDR panorama comprises using a third machine learning model trained as a convolutional autoencoder to generate the HDR panorama based on the LDR panorama.

7. The method of claim 1, wherein generating the HDR panorama from the LDR panorama comprises:
using a fourth machine learning model a plurality of times to generate a plurality of variably exposed LDR panoramas, the fourth machine learning model being trained as a denoiser to generate a variably exposed LDR panorama from the LDR panorama taking a recentred latent tensor as input; and
converting the LDR panoramas to the HDR panoramas based on a radiance map constructed from the plurality of variably exposed LDR panoramas.

8. The method of claim 7, wherein the fourth machine learning model is configured to be conditioned by the LDR panorama.

9. The method of claim 7, further comprising:
computing a plurality of first aggregations by aggregating the LDR panorama and each output of the fourth machine learning model;
applying at least one high-frequency filter to each first aggregation; and
computing a plurality of second aggregations by aggregating each filtered first aggregation and each corresponding output of the fourth machine learning model,
wherein the radiance map is constructed from the plurality of second aggregations.

10. The method of claim 1, further comprising rendering a virtual object in the HDR panorama using a physics-based render engine.

11. A computing system to generate a high dynamic range (HDR) panorama, the computing system comprising:
a panorama generator configured to generate a low dynamic range (LDR) panorama from a prompt describing a desired aspect of a panorama; and
an LDR-to-HDR converter configured to convert the LDR panorama into the HDR panorama.

12. The system of claim 11, wherein the panorama generator comprises:
a first machine learning model configured for generating a backplate image from the prompt, the first machine learning model trained to generate an image based at least on an input prompt; and
a projection module for generating the LDR panorama from the backplate image by at least one of: projecting the backplate image onto a sphere, and an inpainting module for inpainting the backplate image.

13. The system of claim 12, wherein the first machine learning model is configured to be conditioned by an elevation sketch generated from a camera height input and a camera angle input.

14. The system of claim 12, comprising a training module configured to:
determine a caption for each scene of a dataset comprising scenes annotated with a camera height and a camera angle;
determine lighting parameters for each scene;
generate a training prompt for each scene from the camera height, the camera angle, the caption and the lighting parameters;
label each scene with the corresponding training prompt; and
train the first machine learning model to generate an output scene based at least in part on the training prompt.

15. The system of claim 12, wherein the panorama generator comprises a second machine learning model trained to generate the LDR panorama image based at least on the backplate image, wherein the LDR panorama image corresponds to an inpainting of the backplate image by the inpainting module.

16. The system of claim 11, wherein the LDR-to-HDR converter comprises a third machine learning model trained as a convolutional autoencoder to generate the HDR panorama based on the LDR panorama.

17. The system of claim 11, wherein the LDR-to-HDR converter comprises a fourth machine learning model trained as a denoiser to generate a variably exposed LDR panorama from the LDR panorama taking as input a recentred latent tensor, and LDR-to-HDR converter is configured to:
use the fourth machine learning model a plurality of times to generate a plurality of variably exposed LDR panoramas; and
convert the LDR panoramas to the HDR panoramas based on a radiance map constructed from the plurality of variably exposed LDR panoramas.

18. The system of claim 17, wherein the LDR-to-HDR converter is further configured to:
compute a plurality of first aggregations by aggregating the LDR panorama and each output of the fourth machine learning model;
apply at least one high-frequency filter to each first aggregation; and
compute a plurality of second aggregations by aggregating each filtered first aggregation and each corresponding output of the fourth machine learning model,
wherein the radiance map is constructed from the plurality of second aggregations.

19. The system of claim 11, further comprising a physics-based render engine configured to render a virtual object in the HDR panorama.

20. A non-transitory computer-readable medium having instructions stored thereon which, when executed by one or more processors, cause the one or more processors to:
generate, by a panorama generator, a low dynamic range (LDR) panorama from a prompt describing a desired aspect of a panorama; and
generate, by an LDR-to-HDR converter, an HDR panorama from the LDR panorama.
